(19) United States
(12) Patent Application Publication
(10) Pub. No.: US 2025/0291374 A1
(43) Pub. Date: Sep. 18, 2025

(54) LOW-DROPOUT (LDO) REGULATOR WITH AGGRESSOR CURRENT CANCELLATION

(71) Applicant: QUALCOMM Incorporated, San Diego, CA (US)

(72) Inventor: Yue CHAO, San Diego, CA (US)

(21) Appl. No.: 18/606,211

(22) Filed: Mar. 15, 2024

(51) Int. Cl. G05F 1/575

(52) U.S. Cl. CPC G05F 1/575

(57) ABSTRACT

Techniques and apparatus for supplying power with aggressor current attenuation are provided. One example power supply circuit generally includes a low-dropout (LDO) regulator including an input coupled to a power supply node and an output coupled to a load circuit; a current replicator coupled to the output of the LDO regulator and configured to replicate a scaled version of an aggressor current to generate a fractional aggressor current; a current-steering circuit coupled to the current replicator and configured to replicate and reverse a polarity of the fractional aggressor current to generate a reversed fractional aggressor current; and a current mirror including an input coupled to the current-steering circuit and an output coupled to the power supply node, the current mirror being configured to sink an aggressor adjustment current from the power supply node based on the reversed fractional aggressor current.

### TECHNICAL FIELD

Certain aspects of the present disclosure generally relate to electronic devices and, more particularly, to techniques and apparatus for attenuating aggressor current.

### BACKGROUND

Various electronic circuits operate using a clock signal. The clock signal may be used to synchronize the operations of circuits in electronic systems. With increased operating speeds in more recent devices, the clock signal frequency has continued to increase. The rising and falling edges of the clock signal may cause noise at various nodes in the device, which may adversely impact the operations of other circuits.

As electronic devices and their internal integrated circuit (IC) packages get smaller, the number of external connections from the IC package is reduced. Thus, multiple different types of electronic circuits (e.g., analog circuits, power supply circuits, and digital circuits) may be designed to share a single power supply bump or solder ball, which may not be ideal and can introduce noise (e.g., from high-frequency clock signals and their harmonics) into other circuits. Furthermore, the smaller distance between different types of electronic circuits can lead to increased inductive coupling therebetween, which can also introduce noise.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure provide a power supply circuit. The power supply circuit generally includes a low-dropout (LDO) regulator including a first amplifier and a first transistor, where the first transistor includes a gate coupled to an output of the first amplifier, a source coupled to a power supply node, and a drain coupled to an input of the first amplifier and to a load circuit; a second transistor including a source coupled to the power supply node and a gate coupled to the gate of the first transistor and the output of the first amplifier; a third transistor including a drain coupled to a drain of the second transistor and a source coupled to a reference potential node for the power supply circuit; a second amplifier including a first input coupled to the drain of the first transistor and the input of the first amplifier, a second input coupled to the drain of the second transistor and to the drain of the third transistor, and an output coupled to a gate of the third transistor; a fourth transistor including a source coupled to the reference potential node and a gate coupled to the gate of the third transistor and the output of the second amplifier; a current source coupled between the power supply node and a drain of the fourth transistor; and a current mirror including an input coupled to the current source and to the drain of the fourth transistor and an output coupled to the power supply node.

Certain aspects of the present disclosure provide a power supply circuit. The power supply circuit generally includes an LDO regulator including an input coupled to a power supply node and an output coupled to a load circuit; a current replicator coupled to the output of the LDO regulator and configured to replicate a scaled version of an aggressor current, configured to be generated by the load circuit and pass through the LDO regulator (e.g., through a pass transistor of the LDO regulator) to the power supply node, to generate a fractional aggressor current; a current-steering circuit coupled to the current replicator and configured to replicate and reverse a polarity of the fractional aggressor current to generate a reversed fractional aggressor current; and a current mirror including an input coupled to the current-steering circuit and an output coupled to the power supply node, the current mirror being configured to sink an aggressor adjustment current from the power supply node based on the reversed fractional aggressor current.

Certain aspects of the present disclosure are directed to a method of supplying power. The method generally includes powering a circuit with an LDO regulator, the LDO regulator receiving power from a power supply node; replicating a scaled version of an aggressor current, generated by the circuit and passing through the LDO regulator (e.g., through a pass transistor of the LDO regulator) to the power supply node, to generate a fractional aggressor current; replicating and reversing a polarity of the fractional aggressor current to generate a reversed fractional aggressor current; and based on the reversed fractional aggressor current, sinking an aggressor adjustment current from the power supply node.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example wireless device, in which aspects of the present disclosure may be practiced.

FIG. 2 is a block diagram of an example integrated circuit (IC) package, in which aspects of the present disclosure may be practiced.

FIG. 3A is a block diagram of an example LDO regulator and a circuit for aggressor current reduction, in accordance with certain aspects of the present disclosure.

FIG. 3B is a circuit diagram of the example LDO regulator and the circuit for aggressor current reduction of FIG. 3A, in accordance with certain aspects of the present disclosure.

FIG. 4 is a flow diagram of example operations for supplying power with a power supply circuit, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for sensing generated aggressor current and cancelling, or at least reducing, the aggressor current using a circuit for aggressor current reduction. The aggressor current may be generated by an aggressor circuit and may flow through a low-dropout (LDO) regulator coupled to a power supply node. The circuit for aggressor current reduction may be coupled to the LDO regulator and the power supply node, and may include a current replicator, a current-steering circuit, and a current mirror.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCSs), personal digital assistants (PDAs), Internet of Things (IoT) devices, and the like.

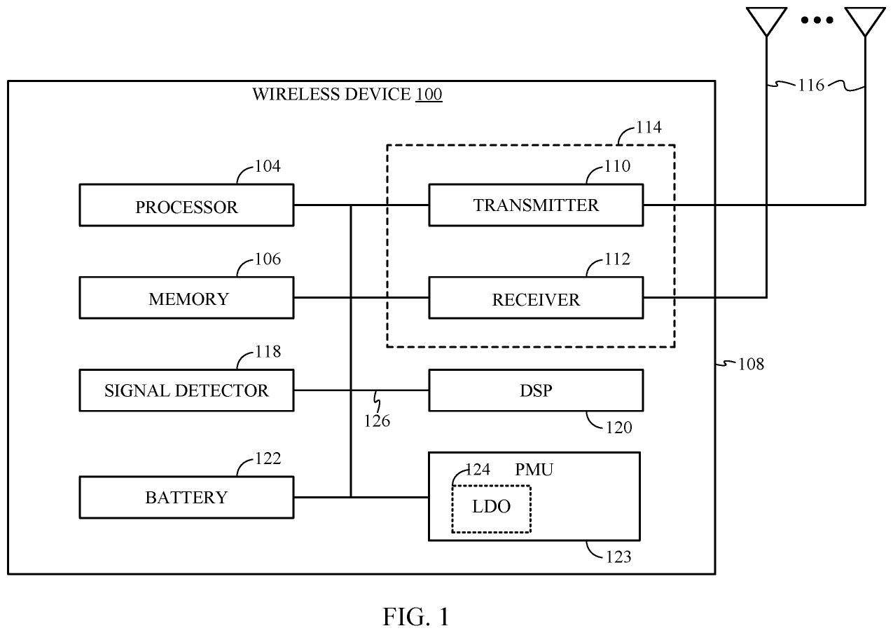

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an IoT device, a wearable device, an augmented reality device, etc.

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a transmitter 110 and/or a receiver 112 to allow transmission and/or reception, respectively, of data between the device 100 and a remote location. In some cases, the transmitter 110 and receiver 112 may be combined into a transceiver 114. One or more antennas 116 may be attached or otherwise coupled to a housing 108 of the device 100 and electrically coupled to the transceiver 114. For certain aspects, the device 100 may include multiple transmitters, multiple receivers, and/or multiple transceivers (not shown).

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing digital signals.

The device 100 may further include a battery 122, which may be used to power the various components of the device 100 (e.g., when another power source—such as a wall adapter or a wireless power charger—is unavailable). The battery 122 illustrated in FIG. 1 may represent multiple portable power sources, such as a main battery and a backup battery (or a supercapacitor). In some cases, the battery 122 may be rechargeable.

The device 100 may also include a power management unit (PMU) 123 for managing the power from the battery 122 (or batteries), a wall adapter, and/or a wireless power charger to the various components of the device 100. At least a portion of the PMU 123 may be implemented in one or more power management integrated circuits (power management ICs or PMICs). The PMU 123 may perform a variety of functions for the device 100 such as DC-to-DC conversion, battery charging, power-source selection, voltage scaling, power sequencing, etc. For example, the PMU 123 may include a battery charging circuit (e.g., a master-slave battery charging circuit) for charging the battery 122. The PMU 123 may include one or more power supply circuits, which may include at least one low-dropout (LDO) voltage regulator 124 and/or at least one switched-mode power supply (SMPS) (not illustrated). The switched-mode power supply may be implemented by any of various suitable switched-mode power supply circuit topologies, such as a buck converter, a boost converter, a buck-boost converter, or a charge pump.

The various components of the device 100 may be coupled together by a bus system 126. The bus system 126 may include a power bus, a control signal bus (e.g., system power management interface (SPMI) or inter-integrated circuit (I²C) bus), and/or a status signal bus in addition to a data bus. Additionally or alternatively, various combinations of the components of the device 100 may be coupled together by one or more other suitable techniques.

### Example Aggressor Current Generation

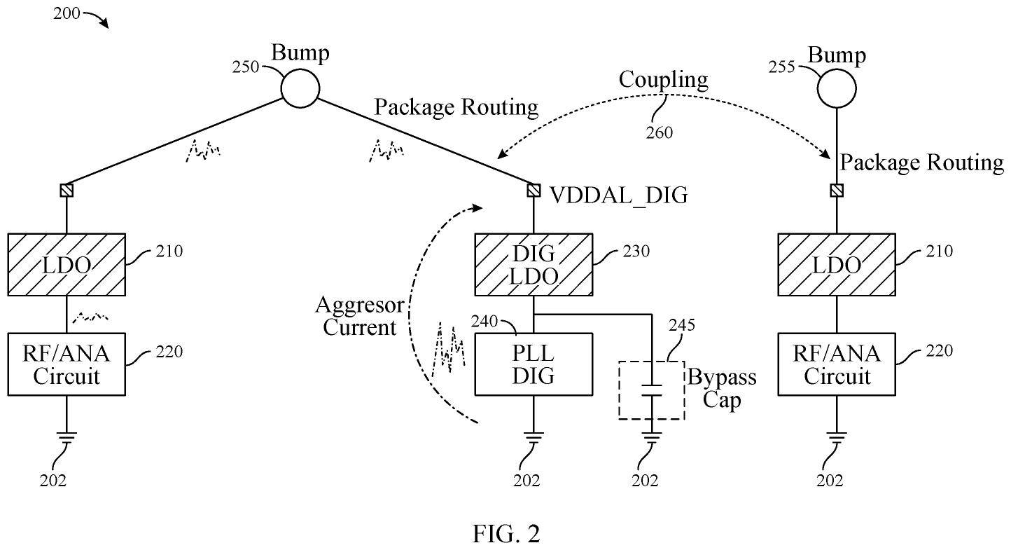

Harmonics of clock signals in mixed-signal, digital, and clock-generation circuits may create spurs on a power supply node, a ground node, and/or on a substrate that can couple to sensitive parts of an integrated circuit (IC). FIG. 2 is a block diagram of an example IC package 200, in which aspects of the present disclosure may be practiced. The IC package 200 may include one or more voltage regulators 210 (e.g., LDO regulators, labeled “LDO”), radio frequency (RF) and other analog (ANA) circuits 220 (e.g., such as a voltage-controlled oscillator (VCO)/local oscillator (LO), labeled “RF/ANA Circuit”), a digital (DIG) LDO 230 (labeled “DIG LDO”), and a phase-locked loop (PLL) for digital circuits 240 (labeled “PLL DIG”). The RF and other ANA circuits 220 and the PLL DIG 240 may each be coupled to a reference potential node 202 (e.g., electrical ground, which may be separated into analog electrical ground and digital electrical ground), and the one or more voltage regulators 210 may each be coupled to a power supply connection 250, 255 (e.g., solder bumps, balls, pads, or the like of the IC package 200), as shown.

In some cases, clock-driven circuits included in the IC package 200 (e.g., PLL DIG 240, which may a phase frequency detector (PFD), a charge pump (CP), fractional frequency divider (NDIV), and a digital-to-time converter (DTC)) may generate significant aggressor currents (e.g., current noise) at harmonic frequencies of the clock frequency, for example. The aggressor currents may be introduced into the sensitive RF and other ANA circuits 220 of the IC package 200 via package routing—such as through the power supply connection 250 (e.g., a solder bump) coupled to a digital power supply rail (labeled “VDDAL_DIG”)—and/or package coupling 260, as illustrated in FIG. 2. This may lead to a large spur in the frequency spectrum, which may cause desense or emission issues.

In certain aspects, a bypass capacitor 245 (labeled “Bypass cap”) may be placed on a power supply output voltage node (e.g., the output of the DIG LDO 230) to sink the generated aggressor current, as illustrated in FIG. 2. However, the capacitance and area of the bypass capacitor 245 may be very large (e.g., hundreds of picofarads (pF)), which would occupy substantial real estate in the IC package 200.

### Example Circuit for Aggressor Current Reduction

Certain aspects of the present disclosure provide techniques and apparatus for sensing (or replicating) aggressor current and cancelling, or at least reducing, the aggressor current. The aggressor current reduction may be implemented without using a large bypass capacitor.

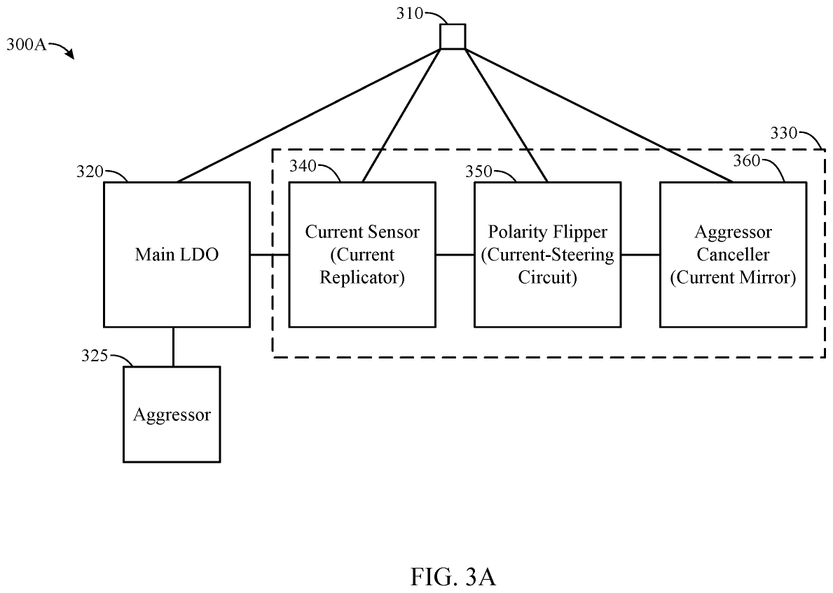

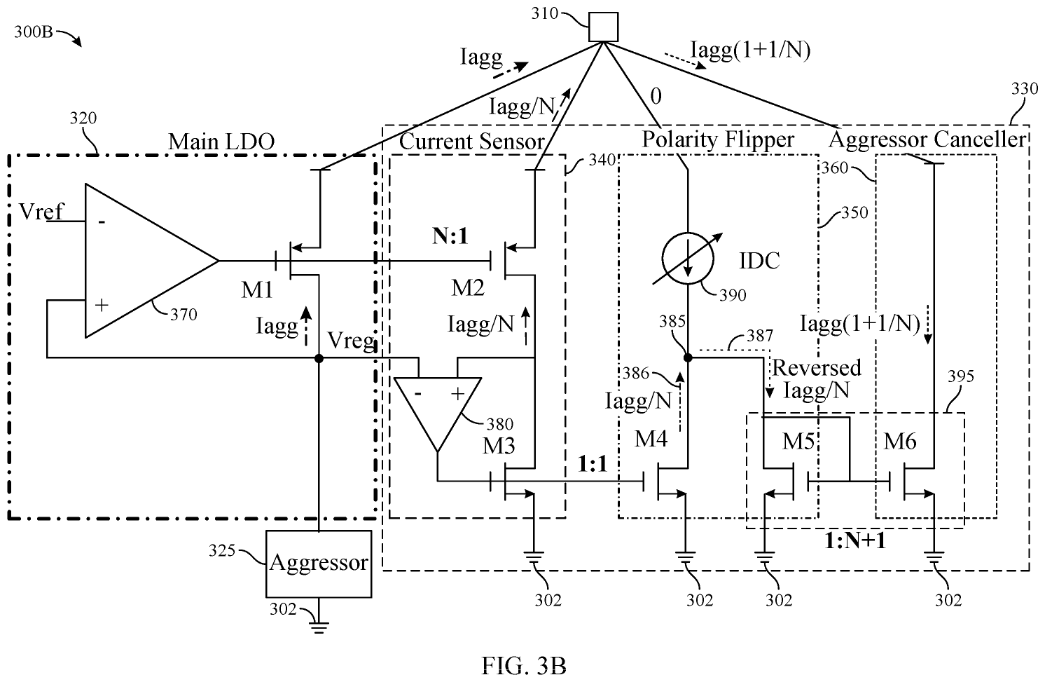

FIG. 3A is a block diagram 300A of an example LDO regulator 320 (labeled “Main LDO”) and a circuit for aggressor current reduction 330, in accordance with certain aspects of the present disclosure. The circuit for aggressor current reduction 330 may be coupled to a power supply node 310 (e.g., a bump, ball, pad, or the like) of an IC package (e.g., the power supply connection 250 of the IC package 200), which is also coupled to an input of the LDO regulator 320. An output of the LDO regulator 320 may be coupled to an aggressor circuit 325 (labeled “Aggressor”), which may be a PLL or other clock-driven circuit, for example. The LDO regulator 320 may be used to regulate an output voltage for powering the aggressor circuit 325, which may also be referred to as a load circuit. The aggressor circuit 325 may be configured to operate with a clock signal or an oscillating signal that contributes to an aggressor current provided to the power supply node 310 (e.g., through a pass transistor of the LDO regulator 320).

The circuit for aggressor current reduction 330 may include a current sensor 340, a polarity flipper 350, and an aggressor canceller 360, as shown. The current sensor 340 may be considered and/or referred to as a current replicator, and may include an input coupled to the LDO regulator 320. The polarity flipper 350 may be considered and/or referred to as a current-steering circuit, and may include an input coupled to an output of the current sensor 340. The aggressor canceller 360 may be considered and/or referred to as a current mirror or current source/sink, and may include an input coupled to an output of the polarity flipper 350 and an output coupled to the power supply node 310. Each of the LDO regulator 320, the current sensor 340, the polarity flipper 350, and the aggressor canceller 360 may be coupled to the power supply node 310, as shown.

As described above, an aggressor current may be generated by the aggressor circuit 325 and pass through the LDO regulator 320 (e.g., through a pass transistor of the LDO regulator 320) to the power supply node 310. The current sensor 340 may be configured to replicate a scaled version of the aggressor current, thereby generating a fractional aggressor current. The polarity flipper 350 may be configured to replicate and reverse a polarity of the fractional aggressor current to generate a reversed fractional aggressor current. The aggressor canceller 360 may be configured to sink an aggressor adjustment current from the power supply node, where the aggressor adjustment current is based on the reversed fractional aggressor current. These functions and example circuits for performing these functions are described in detail below with respect to FIG. 3B.

For certain aspects, one or more blocks in the circuit for aggressor current reduction 330 may include switches (e.g., head switches) for selectively disabling the one or more blocks to save power. For example, there may be certain scenarios (e.g., operating frequency bands) where the aggressor current reduction need not be used, and thus, one or more blocks in the circuit for aggressor current reduction 330 may be disabled by opening these switches to save power. For example, the current sensor 340 may include a first switch coupled to the power supply node 310 and configured to selectively disable the current sensor, the polarity flipper 350 may include a second switch coupled to the power supply node 310 and configured to selectively disable the polarity flipper, and/or the aggressor canceller 360 may include a third switch coupled to the power supply node 310 and configured to selectively disable the aggressor canceller.

FIG. 3B is a circuit diagram of an example power supply circuit 300B with the example LDO regulator 320 and the circuit for aggressor current reduction 330 of FIG. 3A, in accordance with certain aspects of the present disclosure.

The LDO regulator 320 may include a first amplifier 370 (e.g., an error amplifier) and a first transistor M1 (e.g., a p-type metal-oxide-semiconductor (PMOS) transistor), which functions as the pass transistor of the LDO. The first transistor M1 may have a source coupled to the power supply node 310, a drain coupled to a positive input of the first amplifier 370 and a power supply input of the aggressor circuit 325 (at a node labeled “Vreg,” representing the regulated output voltage of the LDO regulator), and a gate coupled to an output of the first amplifier 370. The first amplifier 370 may have a negative input coupled to a reference voltage (labeled “Vref”) and another power supply input of the aggressor circuit 325 may be coupled to a reference potential node 302 (e.g., electrical ground) of the power supply circuit. The aggressor circuit 325 may generate an alternating current (AC) aggressor current (labeled “Iagg”), which may pass through the first transistor M1 to the power supply node 310 and which may be routed to or inductively coupled to other circuits, as described above.

The current sensor 340 may include a second transistor M2 (e.g., a PMOS transistor), a second amplifier 380, and a third transistor M3 (e.g., an n-type metal-oxide-semiconductor (NMOS) transistor). The second amplifier 380 may be implemented as an operational transconductance amplifier (OTA), for example. The second transistor M2 may have a source coupled to the power supply node 310, a drain coupled to a positive input of the second amplifier 380 and a drain of the third transistor M3, and a gate coupled to the gate of the first transistor M1 and the output of the first amplifier 370. In certain aspects, a first switch (not shown) may be coupled between the source of the second transistor M2 and the power supply node 310, and may be configured to selectively disable the current sensor 340, as described above. The second amplifier 380 may have a negative input coupled to the Vreg output of the LDO regulator 320. The third transistor M3 may have a source coupled to the reference potential node 302 and a gate coupled to the output of the second amplifier 380.

The second amplifier 380 and the third transistor M3 may be configured to force a gate-to-source voltage (V_{gs}) of the second transistor M2 to be the same as a V_{gs} of the first transistor M1. The gates of the first transistor M1 and the second transistor M2 are coupled (e.g., shorted) together, such that their gate voltages are the same. The second amplifier 380 is configured to drive the gate of the third transistor M3 such that the positive input of the second amplifier 380 equals Vreg at the negative input of the second amplifier (within an offset voltage of the second amplifier 380), and thus, the drains of the first transistor M1 and the second transistor M2 are also (nearly) the same.

The first transistor M1 and the second transistor M2 may be the same transistor type (e.g., with the same threshold voltage (Vt), and the size ratio between the first transistor M1 and the second transistor M2 may be N:1, as illustrated in FIG. 3B. Thus, the current sensor 340 may be configured to effectively sense the aggressor current generated by the aggressor circuit 325 and flowing through the LDO regulator (e.g., through the pass transistor, such the first transistor M1) and, due to the N:1 size ratio, cause a fraction of the aggressor current (labeled “Iagg/N”) to flow through the second transistor M2, in the same direction as the aggressor current. In this manner, the current sensor 340 replicates a scaled version of the aggressor current. This fractional aggressor current results in a lower power penalty for the current sensor 340, compared to replicating the full aggressor current. N may be a number (e.g., an integer) larger than 1. For example, N may be at least 10 (e.g., 20), such that the fractional aggressor current passing through the second transistor M2 is no larger than one-tenth (e.g., one-twentieth) the aggressor current passing through the first transistor M1. The fractional aggressor current may pass through the second transistor M2 to the power supply node 310 and be added to the aggressor current to form an aggressor-plus-fractional-aggressor current (labeled “Iagg(1+1/N)”), which, without the polarity flipper 350 and the aggressor canceller 360, could potentially enter the power supply node 310 and cause issues as described above.

The polarity flipper 350 may include a current source 390 (labeled “IDC”), a fourth transistor M4 (e.g., an NMOS transistor), and a fifth transistor M5 (e.g., an NMOS transistor). The fourth transistor M4 may have a gate coupled to the gate of the third transistor M3 and the output of the second amplifier 380, a drain coupled to a common node 385, and a source coupled to the reference potential node 302. The third transistor M3 and the fourth transistor M4 may be the same transistor type (e.g., with the same threshold voltage (Vt), and the size ratio between the third transistor M3 and the fourth transistor M4 may be 1:1. Due to this and because the gates of the third transistor M3 and the fourth transistor M4 are driven by the same voltage output from the second amplifier 380, the fractional aggressor current (Iagg/N) “sensed” by the current sensor 340 is replicated (e.g., mirrored) by the fourth transistor M4 to generate a replicated fractional aggressor current.

A first terminal of the current source 390 may be coupled to the power supply node 310, and a second terminal of the current source 390 may be coupled to the common node 385 and to a drain and a gate of the fifth transistor M5. In certain aspects, a second switch (not shown) may be coupled between the first terminal of the current source 390 and the power supply node 310, and may be configured to selectively disable the polarity flipper 350, as described above. The fifth transistor M5 may also have a source coupled to the reference potential node 302. The current source 390 may be implemented by a direct current (DC) source and may be programmable and/or adjustable. For certain aspects, the current source 390 may be implemented by a PMOS current mirror. In some cases, the current source 390 may generate between 10 to 50 microamperes (μA) of current. In certain aspects, the current source 390 may be replaced by an inductor.

Due to the high impedance of the DC current source 390 and the alternate path provided by the fifth transistor M5, the polarity flipper 350 may be configured to route the replicated fractional aggressor current flowing through the fourth transistor M4 to flow through the fifth transistor M5. Thus, the replicated fractional aggressor current flowing from the drain to the source of the fifth transistor M5 has an opposite direction (i.e., reversed or flipped polarity) compared to the replicated fractional aggressor current flowing through the fourth transistor M4. In effect, the polarity of the replicated fractional aggressor current has been reversed to form a reversed fractional aggressor current (labeled “Reversed Iagg/N”).

In some cases, to replicate and reverse the polarity of the fractional aggressor current, the polarity flipper 350 may be configured to replicate the fractional aggressor current in a first path 386 from the reference potential node 302 to the common node 385 and to steer the replicated fractional aggressor current from the common node 385 to the reference potential node 302 in a second path 387. In these cases, the replicated fractional aggressor current in the second path 387 is the reversed fractional aggressor current.

The aggressor canceller 360 may include a sixth transistor M6 (e.g., an NMOS transistor). The sixth transistor M6 may have a gate coupled to the gate and the drain of the fifth transistor M5, a source coupled to the reference potential node 302, and a drain coupled to the power supply node 310. Thus, the fifth transistor M5 and the sixth transistor M6 may collectively function as a current mirror (e.g., current mirror 395), in which the reversed fractional aggressor current functions as a reference current for the current mirror, the fifth transistor M5 is a first branch of the current mirror, and the sixth transistor M6 is a second branch of the current mirror and sinks an output current. In certain aspects, a third switch (not shown) may be coupled between the drain of the sixth transistor M6 and the power supply node 310, and may be configured to selectively disable the aggressor canceller 360, as described above.

The fifth transistor M5 and the sixth transistor M6 may be the same transistor type, and the size ratio between the fifth transistor M5 and the sixth transistor M6 may be 1:N+1, such that the reversed fractional aggressor current is replicated and amplified at the sixth transistor M6 to generate an aggressor adjustment current (labeled “Iagg(1+1/N)”). The aggressor adjustment current may be (N+1)/N times higher than the aggressor current. The aggressor canceller 360 may be configured to inject the aggressor adjustment current with reversed polarity to the power supply node 310 (or effectively sink the equivalent current from the power supply node) to cancel, or at least reduce, the aggressor-plus-fractional-aggressor current (generated by the aggressor circuit 325 and the current sensor 340) at the power supply node 310. In this manner, the aggressor-plus-fractional aggressor current at the power supply node may be canceled or at least reduced before entering other parts of the IC via the power supply node 310. In other words, the aggressor canceller 360 may be configured to sink the aggressor-plus-fractional-aggressor current from the power supply node 310 using the aggressor adjustment current. The aggressor canceller 360 may be configured to sink the aggressor-plus-fractional-aggressor current from the power supply node 310 to reduce at least one of: injection of a portion of the aggressor current into one or more other circuits (e.g., RF and other ANA circuits 220 as shown in FIG. 2) via the power supply node 310, or inductive coupling of the aggressor current to the one or more other circuits.

The circuit for aggressor current reduction 330 described herein may have a small current overhead (e.g., aggressor current harmonics may be much smaller than the current pulled by the current source). For example, the circuit for aggressor current reduction 330 may consume less than 0.5 milliamperes (mA) current from the power supply node 310. In addition, the circuit for aggressor current reduction 330 may be compatible with different types of LDOs (e.g., PMOS/flipped voltage follower (FVF) LDOs). The circuit for aggressor current reduction 330 described herein may also have a feedforward topology, such that the functionality, the control loop, and the stability of the LDO regulator 320 are not affected by the presence of the current sensor 340, the polarity flipper 350, and the aggressor canceller 360. Furthermore, the circuit for aggressor current reduction 330 may be optionally shut down when desired to save power, for example, (for frequency bands) where the benefits of aggressor current cancellation do not outweigh the current consumption. For example, each of the current sensor 340, the polarity flipper 350, and the aggressor canceller 360 may be coupled to the power supply node via switches (e.g., the first switch, the second switch, and the third switch, not shown), and each of the switches may be opened to save power in certain scenarios.

### Example Operations for Supplying Power

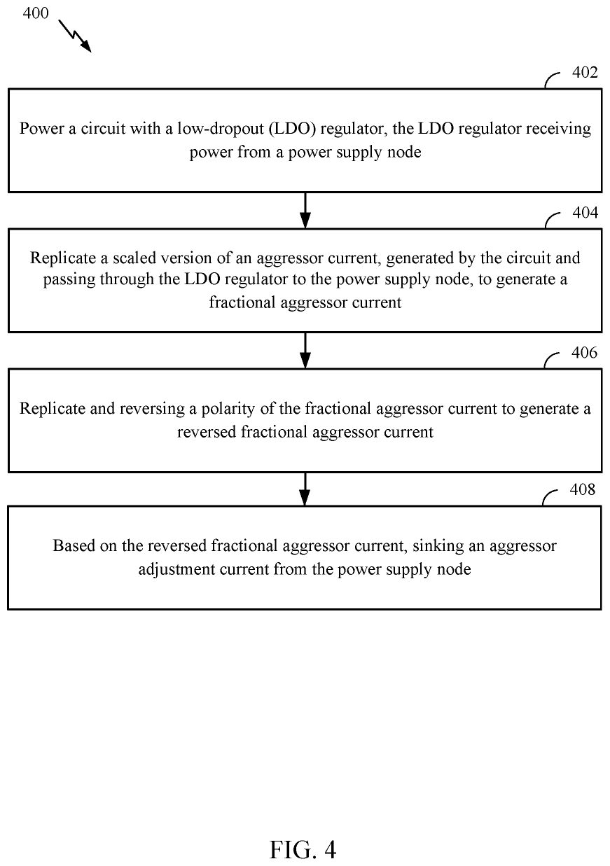

FIG. 4 is a flow diagram illustrating example operations 400 for supplying power, in accordance with certain aspects of the present disclosure. The operations 400 may be performed by a power supply circuit, such as the power supply circuit 300B of FIG. 3B.

The operations 400 may begin, at block 402, powering a circuit (e.g., aggressor circuit 325) with an LDO regulator (e.g., LDO regulator 320), the LDO regulator receiving power from a power supply node (e.g., power supply node 310).

At block 404, a scaled version of an aggressor current (e.g., Iagg), may be replicated to generate a fractional aggressor current (e.g., Iagg/N). The aggressor current may be generated by the circuit and pass through the LDO regulator (e.g., through a pass transistor, such as transistor M1, of the LDO regulator) to the power supply node. In certain aspects, the circuit includes a clock signal or an oscillating signal contributing to the aggressor current.

At block 406, the fractional aggressor current may be replicated and a polarity thereof may be reversed to generate a reversed fractional aggressor current (e.g., Reversed Iagg/N). In certain aspects, replicating and reversing the polarity of the fractional aggressor current may include: (i) replicating the fractional aggressor current in a first path (e.g., first path 386) from a reference potential node (e.g., reference potential node 302) to a common node (e.g., common node 385); and (ii) steering the replicated fractional aggressor current from the common node to the reference potential node in a second path (e.g., second path 387). The replicated fractional aggressor current in the second path may be the reversed fractional aggressor current.

At block 408, an aggressor adjustment current (e.g., Iagg(1+1/N)) from the power supply node may be sunk, based on the reversed fractional aggressor current. In certain aspects, sinking the aggressor adjustment current from the power supply node may reduce at least one of: (i) injection of a portion of the aggressor current into one or more other circuits (e.g., RF and other ANA circuits 220) via the power supply node or (ii) inductive coupling of the aggressor current to the one or more other circuits.

According to certain aspects, the operations 400 may further include replicating a scaled version of the reversed fractional aggressor current to generate the aggressor adjustment current for sinking from the power supply node. In certain aspects, the fractional aggressor current may be provided to the power supply node, the aggressor current may be N times higher than the fractional aggressor current, and the aggressor adjustment current may be (N+1)/N times higher than the aggressor current.

### Example Aspects

In addition to the various aspects described above, specific combinations of aspects are within the scope of the disclosure, some of which are detailed below:

Aspect 1: A power supply circuit comprising: a low-dropout (LDO) regulator including a first amplifier and a first transistor, wherein the first transistor includes a gate coupled to an output of the first amplifier, a source coupled to a power supply node, and a drain coupled to an input of the first amplifier and to a load circuit; a second transistor including a source coupled to the power supply node and a gate coupled to the gate of the first transistor and the output of the first amplifier; a third transistor including a drain coupled to a drain of the second transistor and a source coupled to a reference potential node for the power supply circuit; a second amplifier including a first input coupled to the drain of the first transistor and the input of the first amplifier, a second input coupled to the drain of the second transistor and to the drain of the third transistor, and an output coupled to a gate of the third transistor; a fourth transistor including a source coupled to the reference potential node and a gate coupled to the gate of the third transistor and the output of the second amplifier; a current source coupled between the power supply node and a drain of the fourth transistor; and a current mirror including an input coupled to the current source and to the drain of the fourth transistor and an output coupled to the power supply node.

Aspect 2: The power supply circuit of Aspect 1, wherein the current mirror comprises: a fifth transistor including a drain coupled to the current source and the drain of the fourth transistor, a gate coupled to the drain of the fifth transistor, and a source coupled to the reference potential node; and a sixth transistor including a gate coupled to the gate of the fifth transistor, a drain coupled to the power supply node, and a source coupled to the reference potential node.

Aspect 3: The power supply circuit of Aspect 2, wherein: a first size ratio between the first transistor and the second transistor is N:1; a second size ratio between the third transistor and the fourth transistor is 1:1; and a third size ratio between the fifth transistor and the sixth transistor is 1:N+1.

Aspect 4: The power supply circuit of Aspect 2 or 3, further comprising at least one of: a first switch between the source of the second transistor and the power supply node; a second switch between the current source and the power supply node; or a third switch between the drain of the sixth transistor and the power supply node.

Aspect 5: The power supply circuit of any of the preceding Aspects, wherein the load circuit is configured to operate with a clock signal or an oscillating signal that contributes to an aggressor current provided to the power supply node and wherein the current mirror is configured to sink an aggressor adjustment current from the power supply node to reduce at least one of: injection of a portion of the aggressor current into one or more other circuits via the power supply node; or inductive coupling of the aggressor current to the one or more other circuits.

Aspect 6: The power supply circuit of any of the preceding Aspects, wherein the current source is an adjustable DC current source.

Aspect 7: A power supply circuit comprising: a low-dropout (LDO) regulator including an input coupled to a power supply node and an output coupled to a load circuit; a current replicator coupled to the output of the LDO regulator and configured to replicate a scaled version of an aggressor current, configured to be generated by the load circuit and pass through the LDO regulator to the power supply node, to generate a fractional aggressor current; a current-steering circuit coupled to the current replicator and configured to replicate and reverse a polarity of the fractional aggressor current to generate a reversed fractional aggressor current; and a current mirror including an input coupled to the current-steering circuit and an output coupled to the power supply node, the current mirror being configured to sink an aggressor adjustment current from the power supply node based on the reversed fractional aggressor current.

Aspect 8: The power supply circuit of Aspect 7, wherein the current mirror is configured to replicate a scaled version of the reversed fractional aggressor current to generate the aggressor adjustment current for sinking from the power supply node.

Aspect 9: The power supply circuit of Aspect 7 or 8, wherein the current replicator is configured to provide the fractional aggressor current to the power supply node, wherein the aggressor current is N times higher than the fractional aggressor current, and wherein the aggressor adjustment current is (N+1)/N times higher than the aggressor current.

Aspect 10: The power supply circuit of any of Aspects 7 to 9, wherein the current-steering circuit comprises a common node and wherein to replicate and reverse the polarity of the fractional aggressor current, the current-steering circuit is configured to: replicate the fractional aggressor current in a first path from a reference potential node for the power supply circuit to the common node; and steer the replicated fractional aggressor current from the common node to the reference potential node in a second path, wherein the replicated fractional aggressor current in the second path is the reversed fractional aggressor current.

Aspect 11: The power supply circuit of Aspect 10, wherein the current-steering circuit further comprises a DC current source coupled between the power supply node and the common node.

Aspect 12: The power supply circuit of any of Aspects 7 to 11, wherein by sinking the aggressor adjustment current from the power supply node, the current mirror is configured to reduce at least one of: injection of a portion of the aggressor current into one or more other circuits via the power supply node; or inductive coupling of the aggressor current to the one or more other circuits.

Aspect 13: The power supply circuit of any of Aspects 7 to 12, wherein the power supply node is coupled to the current replicator, the current-steering circuit, and the current mirror.

Aspect 14: The power supply circuit of any of Aspects 7 to 13, wherein at least one of: the current replicator comprises a first switch coupled to the power supply node and configured to selectively disable the current replicator; the current-steering circuit comprises a second switch coupled to the power supply node and configured to selectively disable the current-steering circuit; or the current mirror comprises a third switch coupled between the power supply node and the output of the current mirror, the third switch being configured to selectively disable the current mirror.

Aspect 15: A method for supplying power, the method comprising: powering a circuit with a low-dropout (LDO) regulator, the LDO regulator receiving power from a power supply node; replicating a scaled version of an aggressor current, generated by the circuit and passing through the LDO regulator to the power supply node, to generate a fractional aggressor current; replicating and reversing a polarity of the fractional aggressor current to generate a reversed fractional aggressor current; and based on the reversed fractional aggressor current, sinking an aggressor adjustment current from the power supply node.

Aspect 16: The method of Aspect 15, further comprising replicating a scaled version of the reversed fractional aggressor current to generate the aggressor adjustment current for sinking from the power supply node.

Aspect 17: The method of Aspect 15 or 16, wherein the fractional aggressor current is provided to the power supply node, wherein the aggressor current is N times higher than the fractional aggressor current, and wherein the aggressor adjustment current is (N+1)/N times higher than the aggressor current.

Aspect 18: The method of any of Aspects 15 to 17, wherein replicating and reversing the polarity of the fractional aggressor current comprises: replicating the fractional aggressor current in a first path from a reference potential node to a common node; and steering the replicated fractional aggressor current from the common node to the reference potential node in a second path, wherein the replicated fractional aggressor current in the second path is the reversed fractional aggressor current.

Aspect 19: The method of any of Aspects 15 to 18, wherein sinking the aggressor adjustment current from the power supply node reduces at least one of: injection of a portion of the aggressor current into one or more other circuits via the power supply node; or inductive coupling of the aggressor current to the one or more other circuits.

Aspect 20: The method of any of Aspects 15 to 19, wherein the circuit includes a clock signal or an oscillating signal contributing to the aggressor current.

### ADDITIONAL CONSIDERATIONS

Certain aspects of the present disclosure provide techniques and apparatus for implementing an aggressor current cancellation (or at least mitigation) scheme using amplifier (e.g., OTA) feedback to sense and track aggressor current flowing through an LDO pass device. The scheme uses a polarity flipper to change the current flow direction and injects current with the flipped polarity into the power supply rail (VDD) to cancel (or at least reduce) the aggressor current.

The various operations of methods described above may be performed by any suitable means capable of performing the corresponding functions. The means may include various hardware and/or software component(s) and/or module(s), including, but not limited to a circuit, an application-specific integrated circuit (ASIC), or a processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply circuit comprising:
a low-dropout (LDO) regulator including a first amplifier and a first transistor, wherein the first transistor includes a gate coupled to an output of the first amplifier, a source coupled to a power supply node, and a drain coupled to an input of the first amplifier and to a load circuit;
a second transistor including a source coupled to the power supply node and a gate coupled to the gate of the first transistor and the output of the first amplifier;
a third transistor including a drain coupled to a drain of the second transistor and a source coupled to a reference potential node for the power supply circuit;
a second amplifier including a first input coupled to the drain of the first transistor and the input of the first amplifier, a second input coupled to the drain of the second transistor and to the drain of the third transistor, and an output coupled to a gate of the third transistor;
a fourth transistor including a source coupled to the reference potential node and a gate coupled to the gate of the third transistor and the output of the second amplifier;
a current source coupled between the power supply node and a drain of the fourth transistor; and
a current mirror including an input coupled to the current source and to the drain of the fourth transistor and an output coupled to the power supply node.

2. The power supply circuit of claim 1, wherein the current mirror comprises:
a fifth transistor including a drain coupled to the current source and the drain of the fourth transistor, a gate coupled to the drain of the fifth transistor, and a source coupled to the reference potential node; and
a sixth transistor including a gate coupled to the gate of the fifth transistor, a drain coupled to the power supply node, and a source coupled to the reference potential node.

3. The power supply circuit of claim 2, wherein:
a first size ratio between the first transistor and the second transistor is N:1, N being a number larger than 1;
a second size ratio between the third transistor and the fourth transistor is 1:1; and
a third size ratio between the fifth transistor and the sixth transistor is 1:N+1.

4. The power supply circuit of claim 2, further comprising at least one of:
a first switch between the source of the second transistor and the power supply node;
a second switch between the current source and the power supply node; or
a third switch between the drain of the sixth transistor and the power supply node.

5. The power supply circuit of claim 1, wherein the load circuit is configured to operate with a clock signal or an oscillating signal that contributes to an aggressor current provided to the power supply node and wherein the current mirror is configured to sink an aggressor adjustment current from the power supply node to reduce at least one of:
injection of a portion of the aggressor current into one or more other circuits via the power supply node; or
inductive coupling of the aggressor current to the one or more other circuits.

6. The power supply circuit of claim 1, wherein the current source is an adjustable DC current source.

7. A power supply circuit comprising:
a low-dropout (LDO) regulator including an input coupled to a power supply node and an output coupled to a load circuit;
a current replicator coupled to the output of the LDO regulator and configured to replicate a scaled version of an aggressor current, configured to be generated by the load circuit and pass through the LDO regulator to the power supply node, to generate a fractional aggressor current;
a current-steering circuit coupled to the current replicator and configured to replicate and reverse a polarity of the fractional aggressor current to generate a reversed fractional aggressor current; and
a current mirror including an input coupled to the current-steering circuit and an output coupled to the power supply node, the current mirror being configured to sink an aggressor adjustment current from the power supply node based on the reversed fractional aggressor current.

8. The power supply circuit of claim 7, wherein the current mirror is configured to replicate a scaled version of the reversed fractional aggressor current to generate the aggressor adjustment current for sinking from the power supply node.

9. The power supply circuit of claim 8, wherein the current replicator is configured to provide the fractional aggressor current to the power supply node, wherein the aggressor current is N times higher than the fractional aggressor current, and wherein the aggressor adjustment current is (N+1)/N times higher than the aggressor current, N being a number larger than 1.

10. The power supply circuit of claim 7, wherein the current-steering circuit comprises a common node and wherein to replicate and reverse the polarity of the fractional aggressor current, the current-steering circuit is configured to:
replicate the fractional aggressor current in a first path from a reference potential node for the power supply circuit to the common node; and
steer the replicated fractional aggressor current from the common node to the reference potential node in a second path, wherein the replicated fractional aggressor current in the second path is the reversed fractional aggressor current.

11. The power supply circuit of claim 10, wherein the current-steering circuit further comprises a DC current source coupled between the power supply node and the common node.

12. The power supply circuit of claim 7, wherein by sinking the aggressor adjustment current from the power supply node, the current mirror is configured to reduce at least one of:
injection of a portion of the aggressor current into one or more other circuits via the power supply node; or
inductive coupling of the aggressor current to the one or more other circuits.

13. The power supply circuit of claim 7, wherein the power supply node is coupled to the current replicator, the current-steering circuit, and the current mirror.

14. The power supply circuit of claim 7, wherein at least one of:
the current replicator comprises a first switch coupled to the power supply node and configured to selectively disable the current replicator;
the current-steering circuit comprises a second switch coupled to the power supply node and configured to selectively disable the current-steering circuit; or
the current mirror comprises a third switch coupled between the power supply node and the output of the current mirror, the third switch being configured to selectively disable the current mirror.

15. A method for supplying power, the method comprising:
powering a circuit with a low-dropout (LDO) regulator, the LDO regulator receiving power from a power supply node;
replicating a scaled version of an aggressor current, generated by the circuit and passing through the LDO regulator to the power supply node, to generate a fractional aggressor current;
replicating and reversing a polarity of the fractional aggressor current to generate a reversed fractional aggressor current; and
based on the reversed fractional aggressor current, sinking an aggressor adjustment current from the power supply node.

16. The method of claim 15, further comprising replicating a scaled version of the reversed fractional aggressor current to generate the aggressor adjustment current for sinking from the power supply node.

17. The method of claim 16, wherein the fractional aggressor current is provided to the power supply node, wherein the aggressor current is N times higher than the fractional aggressor current, and wherein the aggressor adjustment current is (N+1)/N times higher than the aggressor current, N being a number larger than 1.

18. The method of claim 15, wherein replicating and reversing the polarity of the fractional aggressor current comprises:
replicating the fractional aggressor current in a first path from a reference potential node to a common node; and
steering the replicated fractional aggressor current from the common node to the reference potential node in a second path, wherein the replicated fractional aggressor current in the second path is the reversed fractional aggressor current.

19. The method of claim 15, wherein sinking the aggressor adjustment current from the power supply node reduces at least one of:
injection of a portion of the aggressor current into one or more other circuits via the power supply node; or
inductive coupling of the aggressor current to the one or more other circuits.

20. The method of claim 15, wherein the circuit includes a clock signal or an oscillating signal contributing to the aggressor current.
